(19) United States
(12) Patent Application Publication
(10) Pub. No.: US 2026/0299372 A1
(43) Pub. Date: Oct. 1, 2026

(54) Monolithically Integrated Photon Pair Source

(71) Applicants: Fraunhofer-Gesellschaft zur Förderung der angewandten Forschung e.V., München (DE); Ferdinand-Braun-Institut gGmbH Leibniz-Institut für Höchstfrequenztechnik, Berlin (DE)

(72) Inventors: Hans Wenzel, Berlin (DE); Jan-Philipp Koester, Berlin (DE); Thomas Tenzler, Falkensee (DE); Yang Quankui, Freiburg (DE); Thorsten Passow, Freiburg (DE)

(21) Appl. No.: 19/565,112

(22) Filed: Mar. 12, 2026

(30) Foreign Application Priority Data
Mar. 14, 2025 (DE) 10 2025 109 998.7

(51) Int. Cl. G02F 1/39

(52) U.S. Cl. CPC G02F 1/395; G02F 2201/346; G02F 2203/02

(57) ABSTRACT

The present disclosure relates to a monolithically integrated photon pair source, in particular a monolithically constructed waveguide stack arranged to provide quantum-mechanically entangled photon pairs by means of Spontaneous Parametric Down Conversion (SPDC). A monolithically integrated photon pair source according to the present disclosure comprises a dielectric waveguide (DWL); and a Bragg reflection waveguide (BRWL) arranged to provide quantum-mechanically entangled photon pairs by means of spontaneous parametric down conversion, wherein the BRWL is disposed below the DWL and they are interacting with one another in a common coupling portion (KA) such that pump radiation guided in the DWL is cross-coupled into the BRWL.

This application claims foreign priority benefit under 35 U.S.C. § 119 of the German Patent Application No. 10 2025 109 998.7, filed Mar. 14, 2025, the disclosure of which is incorporated herein by reference.

### DESCRIPTION

The present invention relates to a monolithically integrated photon pair source, in particular a monolithically constructed waveguide stack arranged to provide quantum-mechanically entangled photon pairs by means of Spontaneous Parametric Down Conversion (SPDC).

### STATE OF THE ART

In recent years, the use of entangled photon pairs has become a central field of research in quantum physics and quantum technology. The quantum-mechanical correlations that arise from quantum entanglement offer the potential for novel applications in a wide variety of fields.

One important area of application is quantum communication, in particular quantum cryptography. Tap-proof communication channels can be realized using said entanglement. Quantum Key Distribution (QKD) uses said entanglement to transmit encryption keys in such a way that any eavesdropping is detected immediately. The development of satellite-based quantum communication has shown that entangled photons can be transmitted over long distances, including space, significantly extending the range and security of quantum communication.

In quantum metrology, entangled photons enable improvements in measurement precision. Quantum sensors based on entanglement offer the potential to be much more sensitive than conventional sensors. This enables applications in atomic clock technology, gravitational wave detection and high-precision spectroscopy. By using entangled states, measurements can be carried out with an accuracy that would not be achievable with conventional methods.

In addition to the areas of application mentioned, there are other areas in which entangled photons play a role. These include, for example, quantum imaging, quantum simulation, quantum computing and basic research for quantum physics.

The current challenges in the development of these applications include in particular the development of efficient and robust sources for entangled photons as well as the miniaturization and integration of quantum devices.

The development of integrated photonic systems for generating entangled photon pairs represents a decisive step forward for the practical application of quantum technologies. In most cases, entangled photons are still provided with optical constructions composed of individual components, which often leads to large, unstable systems that are difficult to miniaturize. The integration of such photon pair sources at chip level, on the other hand, enables the realization of compact, robust and scalable quantum devices.

A common method for the integrated generation of entangled photon pairs is based on waveguides. Here, nonlinear optical effects in waveguides are used to generate photon pairs. In particular, Spontaneous Parametric Down Conversion (SPDC), which is also referred to as parametric fluorescence or spontaneous parametric fluorescence, and Spontaneous Four-Wave Mixing (SFWM) are widely used methods. In SPDC, a pump photon is converted into two photons with lower energy in a nonlinear material, wherein an appropriate choice of material and waveguide geometry can generate entangled photon pairs. Lithium niobate waveguides are particularly promising for photon pair generation using SPDC due to their strong nonlinearity and the possibility of implementing them in integrated circuits. In SFWM, on the other hand, two pump photons interact in a nonlinear material and generate a signal photon and an idler photon. Silicon waveguides are particular attractive for SFWM-based generation of entangled photon pairs due to their compatibility with the CMOS technology and their high nonlinearity. However, in addition to lithium niobate and silicon, other materials such as aluminum gallium arsenide (AlGaAs) and silicon nitride (Si₃N₄) are also suitable for forming such nonlinear waveguides for photon pair generation.

A particularly promising approach for the generation of entangled photon pairs using SPDC is the use of Bragg reflection waveguides (BRWL). Their design, based on Bragg gratings, allows flexible control of phase matching, a crucial factor for SPDC. The targeted design of the layer structure enables phase matching for specific wavelengths and materials. This can lead to an increased interaction between the photons and the nonlinear material, which increases the efficiency of nonlinear processes. The ability to generate both homo-and cross-polarized photon pairs is another advantage, especially for applications in quantum communication and quantum computing.

In particular, BRWLs based on AlGaAs are known in the related art. The Bragg waveguide consists of a core region and surrounding layers with alternating aluminum content (the so-called Bragg reflector pairs). As a result, the basic modes of the waveguide are guided in the core at high wavelengths and a higher vertical mode is formed for the short-wavelength light enclosed in the core area, which is usually referred to as the “Bragg mode”. Phase matching can be established between the Bragg mode in the short-wavelength range and the two basic modes in the long-wavelength range (see Abolghasem, P., et al. “Monolithic photonics using second-order optical nonlinearities in multilayer-core Bragg reflection waveguides.” IEEE Journal of Selected Topics in Quantum Electronics 18.2(2011): 812-825.).

The short-wavelength light is usually laser light that is either coupled directly into the waveguide via optical pumping (passive component) or generated by electrical operation within an active zone integrated into the core of the BRWL (active component). The latter variant of the component thus enables the simultaneous generation of laser radiation at 775 nm and entangled photons at 1550 nm, for example. However, the introduction of the active zone exerts a non-negligible influence on the phase matching and thus also on the conversion wavelength of the SPDC process. In addition, the laser design and the conversion design cannot be optimized independently of one another, but a compromise must be chosen (see Bijlani, B. J., and A. S. Helmy. “Design methodology for efficient frequency conversion in Bragg reflection lasers.” Journal of the Optical Society of America B 29.9(2012): 2484-2492.).

### DISCLOSURE OF THE INVENTION

It is therefore an object of the present invention to provide a monolithically integrated photon pair source which overcomes or at least significantly mitigates the disadvantages of the prior art. In particular, a monolithically integrated photon pair source for providing quantum-mechanically entangled photon pairs by means of Spontaneous Parametric Down Conversion (SPDC) is to be provided, wherein the structural and geometric properties of the BRWL can be optimized and adapted for improved conversion efficiency largely independently of the structures required for providing the pump radiation. Above all, in the case of an active component, the laser design and the conversion design shall be able to be optimized independently of one another.

These objects are solved according to the invention by the features of independent claims. Useful embodiments of the invention are contained in the associated dependent claims. The features listed individually in the claims can be combined with one another in a technologically meaningful way and can be supplemented by explanatory facts from the description and/or details from the figures, wherein further preferred embodiments of the invention are shown.

One aspect of the invention relates to a monolithically integrated photon pair source, comprising a dielectric waveguide (DWL); and a Bragg reflection waveguide (BRWL) arranged to provide quantum-mechanically entangled photon pairs by means of Spontaneous Parametric Down Conversion (SPDC), wherein the BRWL is disposed below the DWL and they are interacting with one another in a common coupling portion such that pump radiation guided in the DWL is cross-coupled into the BRWL.

The idea of the present invention thus resides, in particular, in a monolithically constructed waveguide stack arranged to provide quantum-mechanically entangled photon pairs by means of spontaneous parametric down conversion. Single-mode DWLs for guiding monochromatic light are well known in the related art. The use of BRWLs to provide quantum-mechanically entangled photon pairs by means of spontaneous parametric down conversion and the associated methods for adjusting the phase matching while optimizing the conversion efficiency at the same time are also well-known to the person skilled in the art from the related art. According to the invention, however, these two technologies known per se are combined in such a way that a DWL and the BRWL are arranged one above the other in a monolithic platform in such a way that they have a common coupling portion in which they interact with each other in such a way that a pump radiation guided in the DWL is cross-coupled into the BRWL. Waveguide-based integrated vertical coupler structures are also well-known to the person skilled in the art for DWLs, but such a combination of a DWL with a BRWL arranged for cross-coupling a pump radiation guided in the DWL into the BRWL to provide quantum-mechanically entangled photon pairs by means of spontaneous parametric down conversion is neither disclosed in the related art nor suggested to the person skilled in the art.

Here, the coupling portion is referred to a quasi-parallel distance along the longitudinal direction of both waveguide structures that is arranged for the corresponding cross-coupling. However, the quasi-parallel formation of the two waveguide structures is not limited to the coupling portion; rather, the two waveguide structures can also extend together along a common direction beyond the actual coupling portion. Preferably, however, the two waveguide structures only have a small mutual coupling outside the actual coupling portion. The term “quasi-parallel” means that the two waveguides approach each other for mutual coupling along a certain distance in such a way that a certain field overlap occurs. However, this does not mean that the two waveguides have to be arranged strictly parallel in the mathematical sense; rather, the distance between the waveguides in the coupling portion can also be variable or modulated.

Preferably, a monolithically integrated photon pair source according to the invention is realized entirely in an AlGaAs-based material, i.e. both the DWL and the BRWL are formed from a correspondingly doped or intrinsic AlGaAs material. The underlying substrate can preferably be a GaAs substrate. However, this is not intended to be a restriction with regard to the material system used; rather, a plurality of different materials are suitable for forming corresponding waveguide stacks. Depending on the required wavelength range for the photon pairs, these can be selected accordingly and optimized with regard to the desired optical and electronic properties.

Preferably, the DWL is formed as a passive waveguide with an input for coupling in the pump radiation. In this case, the pump radiation must first be coupled into the DWL in a suitable manner before being cross-coupled into the BRWL. The pump radiation can be provided externally, for example by means of an external laser. However, the laser can also be formed as a further component on the monolithically integrated photon pair source according to the invention. It is also possible to integrate a laser with or into the DWL outside the coupling portion. However, the DWL described according to the invention is still referred to as a passive waveguide in this case, as the portion of the DWL relevant to the invention still has no active laser structures and the pump radiation is also guided there exclusively passively, as in the case of external coupling. The DWL can, for example, be formed as a planar ridge or strip waveguide and comprise one or more clad layers in addition to a waveguide layer.

In a preferred alternative embodiment, the DWL is formed as an active waveguide with an active layer. The basic structure of the DWL can correspond to a passive DWL described above, wherein the active layer is formed within a wave-guiding layer. The active DWL can be formed as a directly electrically pumped or optically pumped laser structure. The integration of a conventional diode laser structure with a radiating p-n junction directly into the waveguide is particularly preferred. In particular, the active waveguide may comprise an AlGaAs-based diode laser structure with, for example, GaInAsP as the active layer. A DWL formed as an active waveguide can have DFB or DBR laser structures and can therefore also be arranged as a DFB or DBR laser.

Preferably, the DWL is formed as a ridge waveguide with an electrode disposed on a ridge and a contact layer disposed on the lower surface of the DWL. Providing and optimizing ridge waveguide structures are also well-known to those skilled in the art. Ridge waveguide structures enable effective lateral mode guiding within the active waveguide. The specific design of the ridge and the surrounding layers creates a refractive index difference that restricts the light to the core of the waveguide. This leads to a reduction in mode losses and improved beam quality. Another significant advantage of ridge waveguides is the possibility of optimizing the current injection into the active material. The ridge structure also enables precise control of the current distribution, which leads to more efficient excitation of the active layer. In addition, ridge waveguide structures offer a high degree of flexibility when adapting the waveguide geometry. This makes it possible to specifically influence the laser properties such as the mode size, divergence and output power. By varying the ridge width and height, the optical properties of the waveguide can be precisely adjusted to meet the requirements of specific applications. By forming the electrode on the ridge and a contact layer disposed on the lower surface of the DWL, effective energization of the active layer can take place without the current flow leading to impairment of the BRWL. The active DWL and the BRWL disposed below it can therefore be implemented and optimized functionally largely independently of each other.

Preferably, the BRWL has a cladding layer on its upper surface. The cladding layer (this term is used to distinguish it from the clad layer of the DWL) is used as a matching and spacer layer to adjust the distance between the respective wave-guiding layers. However, their thickness should not be too great in order to allow sufficient cross-coupling between the structures. For example, the thickness of the cladding layer can be between about 50 nm and 500 nm, preferably about 200 nm. Sufficient confinement of the laser mode in the DWL can be achieved using a low-refractive cladding layer.

Preferably, the BRWL comprises a waveguide layer surrounded at least below by at least one Bragg reflector pair. In addition to the two elements mentioned, the BRWL can also include other layers, such as additional matching, cladding, spacer and/or etch stop layers. The waveguide layer must be arranged in such a way that it can guide both the pump radiation cross-coupled from the DWL and the conversion radiation generated by the nonlinear processes taking place in it with the entangled photon pairs. The specific geometric and structural embedding of the waveguide layer into the surroundings can be used to realize the interaction required for an effective conversion process by means of phase matching. A vertical downward limitation of the waveguide in the BRWL is provided by the at least one Bragg reflector pair below the waveguide layer. A vertical upward limitation of the waveguide in the BRWL can also be achieved by at least one additional Bragg reflector pair above the waveguide layer. However, vertical upward limitation of the waveguide in the BRWL can also be achieved without such a Bragg reflector pair located above the waveguide layer on other structures, for example on an appropriately arranged overlying cladding layer or an exposed interface (e.g. by structural etching). In a conventional BRWL according to the prior art, the number of Bragg reflector pairs above and below the waveguide layer is symmetrically formed, i.e. there are the same number of Bragg reflector pairs above and below.

However, in a monolithically integrated photon pair source according to the invention, the number of Bragg reflector pairs above and below the waveguide layer is preferably formed asymmetrically. In particular, the number above the waveguide layer can be less than that below the waveguide layer. If the extension of an optional cladding layer of the BRWL is too large or the number of Bragg reflector pairs on the upper surface of the BRWL is too high, it may not be possible to cross-couple the pump radiation between the DWL and the BRWL. Under certain circumstances, there may be no overlap in the spatial distribution between the Bragg mode in the BRWL and the pump mode in the DWL and thus no coupling between the two waveguide structures can occur even if the effective refractive indices match.

Therefore, the number of Bragg reflector pairs in the BRWL above the waveguide layer can be reduced asymmetrically to just one Bragg reflector pair, for example. Below the waveguide layer, a reduction of the Bragg reflector pairs is not necessary, which is why, for example, 4 to 10 Bragg reflector pairs, preferably 6 Bragg reflector pairs, can support the light confinement there. Despite this asymmetry, the formation of the Bragg mode in the BRWL is still possible. In order to ensure sufficiently high light confinement of the pump radiation in the BRWL, for example, a relatively thin cladding layer, preferably with a high aluminum content, can be used in the AlGaAs material system mentioned.

Preferably, in the coupling direction first a tapering of the lateral width of the DWL and subsequently a tapering of the lateral width of the BRWL occurs, wherein the smallest lateral width of the BRWL in the common coupling portion KA is greater than the largest lateral width of the DWL. Lateral taperings have already been used for SPDC in a stacked waveguide based on AlGaAs (see Gerini, A., et al. “Electrically injected InGaAsP/AlGaAs optical parametric oscillator: design and technology.” JOSA B 38.8(2021): B40-B45.). However, the waveguide for the conversion was not a BRWL here. In addition, the contact layer material used there was based on GaAs. This meant that a lateral tapering in two stages (two lithography levels/etchings) was sufficient. In the first stage, the ridge of the DWL was removed, while in the second stage the upper waveguide itself was removed. This made it possible to realize a coupling between the laser mode and the second upper mode of the lower waveguide.

A lateral tapering of waveguides can be used to optimize the vertical coupling of radiation between two index-carrying layers. In particular, such an approach offers the possibility of optimizing individual portions of the same wafer for separate tasks of a component (see Studenkov, P. V., Gokhale, M. R., and Forrest, S. R. “Efficient coupling in integrated twin-waveguide lasers using waveguide tapers.” IEEE Photonics Technology Letters 11.9(1999): 1096-1098.). As the width of the DWL is reduced, the effective refractive index of the guided pump mode is reduced, which is why is matches the effective refractive index of the mode of the BRWL, which enables resonant and highly efficient coupling of the pump radiation from the DWL into the BRWL (see Menon, V. M., Fengnian X., and S. R. Forrest. “Photonic integration using asymmetric twin-waveguide (ATG) technology: part II-devices.” IEEE Journal of selected topics in quantum electronics 11.1(2005): 30-42.).

Preferably, the DWL and the BRWL are tapered in sections within the individual waveguide structures, i.e. at least one tapering of the DWL and one of the BRWL occur. In particular, both the DWL and the BRWL can each have several tapering stages in sections. This staged approach can significantly increase the efficiency of the pump radiation cross-coupling from the DWL into the BRWL compared to a respective single-stage tapering step. In particular, the individual tapering stages can be disposed one behind the other in the coupling direction in such a way that at each tapering there is an increasing lateral expansion of the respective local radiation mode for adaptation to a plane immediately below. This allows a gradually increasing lateral expansion of the radiation mode from a narrow DWL at the top to a wider BRWL below. The tapering stages can occur within a material surrounding the waveguide in the lateral direction (e.g. a lateral clad portion). Preferably, however, the individual tapering stages correspond to etching stages within a layer structure forming the monolithically integrated photon pair source according to the invention. In particular, a correspondingly deeper exposure of an area of the layer structure can be achieved with each subsequent taper step in the coupling direction. A corresponding illustrative example embodiment with a total of 5 such corresponding tapering and etching stages is shown in FIG. 1.

A further aspect of the invention relates to a method for manufacturing a monolithically integrated photon pair source according to the invention, comprising providing a respective planar layer system; and forming the taperings with several consecutive etching steps, wherein deeper layers of the layer system are partially exposed with each etching step. In particular, the method according to the invention relates to the realization of the tapering of the DWL and the BRWL in section as described above. The technical advantages of the method according to the invention result directly from the associated description of the monolithically integrated photon pair source according to the invention.

According to the invention, a DWL is monolithically stacked on a BRWL. Lateral taperings can be used to cross-couple pump radiation generated and/or guided in the DWL into the BRWL, in which the pump radiation is then converted to quantum-mechanically entangled photon pairs using SPDC. This allows a compact monolithically integrated on-chip source for quantum-mechanically entangled photon pairs to be realized. An advantage over a directly electrically pumped simple BRWL from the prior art is in particular that the DWL and the BRWL can be optimized independently of each other for the generation of the pump radiation and for the subsequent SPDC process.

The vertical layer structure of the waveguide stack can be deposited on a common substrate using methods known from the prior art, such as metalorganic vapor phase epitaxy or molecular beam epitaxy. The described multi-stage tapering structure can then be produced by lithography and dry etching methods known from the prior art (e.g. by inductively coupled plasma reactive ion etching, ICP-RIE) by means of etching steps executed sequentially (see Gerini, A., et al. “Electrically injected InGaAsP/AlGaAs optical parametric oscillator: design and technology.” JOSA B 38.8(2021): B40-B45.).

The main difference to the stacked waveguides according to the related art is the use of a BRWL as the lower waveguide for the conversion process. However, the high width of the structure required for phase matching and the deep etching of the BRWL allows the formation of and coupling with higher lateral modes, which are generally undesirable for the SPDC process. If highly refractive InGaP or another material is used for the n-contact, this can lead to a non-negligible amount of radiation in the upper contact layer, which remains even after coupling.

In the present invention, these parasitic effects of radiation guiding of the contact layer and coupling into higher modes can be reduced, in particular by providing a tapering with additional stages (lithography planes/etchings). In the first step, after removing the DWL, an n-contact layer can be removed. In the second step, the BRWL is not etched directly to the target depth for phase matching, but instead a shallow etching is performed first, whereby the Bragg mode is guided in the BRWL, but higher lateral modes are not supported. After completion of the coupling and removal of the contact layer, a deep etching of the BRWL can then be carried out.

The present invention thus enables a provision of quantum-mechanically entangled photon pairs with a compact electrically pumped on-chip source. This is made possible, for example, by direct electrical pumping of an AlGaAs-based Bragg reflection waveguide (BRWL). In this case, however, the BRWL must be suitable both for use as a laser diode and for converting the pump light to generate the entangled photons, which typically requires compromises concerning efficiency. Therefore, the present invention proposes the use of two monolithically stacked waveguide structures (preferably based on AlGaAs), wherein the upper waveguide is for example an actively pumped laser DWL and the lower one is a BRWL and vertical optical coupling is to be provided between both waveguides. This allows the required laser and conversion properties to be set and optimized separately. To improve the required vertical optical coupling, several taperings of the structure can be provided, since the cross-coupling of the pump radiation shall preferably take place between a basic mode of the DWL and a higher mode of the BRWL, in particular the Bragg mode of the BRWL.

Further preferred embodiments of the invention result from the features mentioned in the respective dependent claims.

The various embodiments of the invention mentioned in this application can be advantageously combined with one another, unless otherwise stated in individual cases.

### BRIEF DESCRIPTION OF THE DRAWINGS

The invention and the technical environment are explained in more detail below with reference to the accompanying figures. It should be noted that the invention is not intended to be limited by the exemplary embodiments mentioned. In particular, unless explicitly stated otherwise, it is also possible to extract partial aspects of the facts explained in the figures and combine them with other components and findings from the present description. In the drawings, the following shall apply:

FIG. 1 is a spatial-schematic diagram of an exemplary embodiment of a monolithically integrated photon pair source according to the invention;

FIG. 2 is a cross-sectional view of the photon pair source according to the invention of FIG. 1 in lateral direction along the drawn cutting surface A;

FIG. 3 is a cross-sectional view of the photon pair source according to the invention of FIG. 1 in longitudinal direction along the drawn cutting surface B; and

FIG. 4 is a top view of an exemplary embodiment of a monolithically integrated photon pair source according to the invention to illustrate the several consecutive etching steps in an associated method for manufacturing it.

### DETAILED DESCRIPTION OF THE DRAWINGS

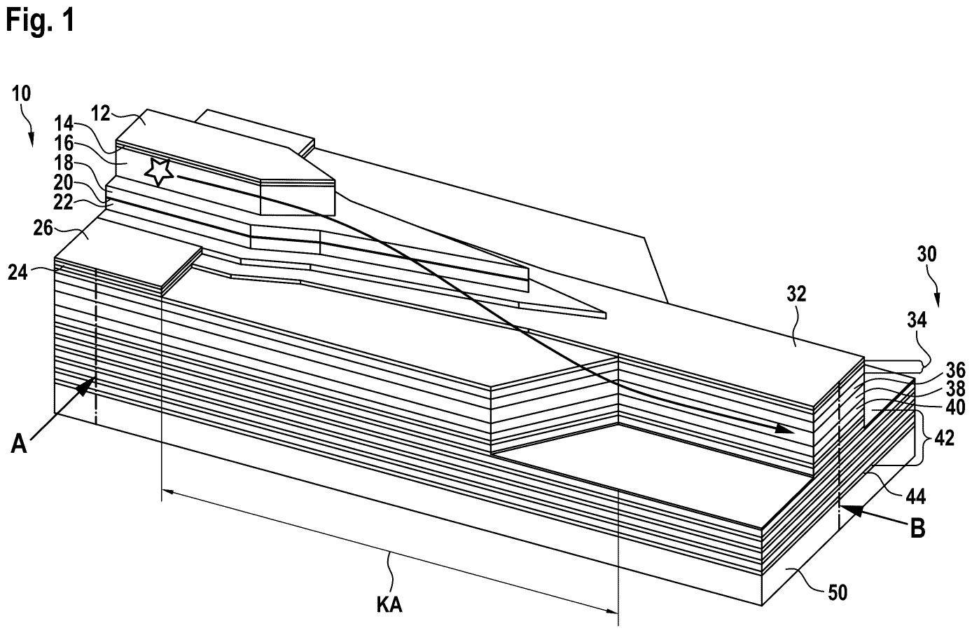

FIG. 1 shows a spatial-schematic diagram of an exemplary embodiment of a monolithically integrated photon pair source according to the invention. The structure shown comprises a dielectric waveguide, DWL, 10; and a Bragg reflection waveguide, BRWL, 30 arranged to provide quantum-mechanically entangled photon pairs by means of spontaneous parametric down conversion, SPDC, wherein the BRWL 30 is disposed below the DWL 10 and they are interacting with one another in a common coupling portion KA such that pump radiation guided in the DWL 10 is cross-coupled into the BRWL 30. In this embodiment, the DWL 10 is formed as an active waveguide with an active layer 20, but it could alternatively also be an externally laser-coupled passive waveguide. The DWL 10 shown is formed as a ridge waveguide with an electrode 12 disposed on a ridge and a contact layer 24 disposed on the lower surface of the DWL 10. The BRWL 30 shown has a cladding layer 32 on its upper surface. The BRWL 30 further comprises a waveguide layer 38 surrounded at least below by at least one Bragg reflector pair 42. The number of Bragg reflector pairs 34, 42 above and below the waveguide layer 38 is formed asymmetrically, in particular the number above the waveguide layer 38 is less than that below the waveguide layer 38. In the coupling direction first a tapering of the lateral width of the DWL 10 and subsequently a tapering of the lateral width of the BRWL 30 occurs, wherein the smallest lateral width of the BRWL 30 in the common coupling portion KA is greater than the largest lateral width of the DWL 10. The tapering of the DWL 10 and the BRWL 30 each occurs in sections within the individual waveguide structures.

The DWL 10 and the BRWL 30 can be disposed in a stacked manner on top of each other on a common substrate 50. The DWL 10 can have a typical planar layer structure with a ridge waveguide structure. In the exemplary embodiment shown, the ridge is formed from a first electrode 12 (e.g. a p-electrode) for electrical contacting, a first contact layer 14 (e.g. a p-contact layer) arranged below it and a first clad layer 16 (e.g. a p-clad layer) arranged below it. Immediately below this, a first confinement or first waveguide layer 18 (e.g. a p-waveguide layer), an active layer 20 (e.g. a quantum well layer) and a second confinement or second waveguide layer 22 (e.g. an n-waveguide layer) are arranged in that order. In the embodiment shown, they form a first stage below the ridge structure shown. Below this, in the embodiment shown, there is a second stage consisting of a second contact layer 24 (e.g. n-contact layer). For energizing the active DWL, as also shown in the diagram, a partial area of the second contact layer 24 can be provided with a second electrode 26 (e.g. n-electrode) for electrical contacting. The second contact layer 24 may also have a patterning for forming a third stage on the underlying BRWL 30. Although an overlying p-structure and an underlying n-structure are described here, these structures can of course also be formed to be mutually exchanged. A design with at least one intermediate p-n tunnel junction is also possible.

The BRWL 30 shown comprises a first cladding layer 32 (e.g. an upper cladding layer) and a first Bragg reflector 34 (e.g. an upper Bragg reflector, a single Bragg reflector pair is shown as a preferred embodiment) arranged below it for vertically limiting the waveguide upwards. The photon pair generation takes place in the wave-guiding region immediately below in the order described, comprising a first matching layer 36 (e.g. an upper matching layer), a waveguide layer 38 and a second matching layer 40 (e.g. a lower matching layer). A second Bragg reflector 42 (e.g. a lower Bragg reflector, preferably comprising six Bragg reflector pairs) is arranged below to vertically limit the waveguide downwards. To separate these structures from the substrate 50, a second cladding layer 44 (e.g., a lower cladding layer) may further be disposed between the second Bragg reflector 42 and the substrate, as shown. The BRWL shown comprises a total of two stages (in addition to the three stages of the DWL mentioned above). The fourth stage concerns a shallow etching of the first cladding layer 32 to eliminate higher coupling modes, while the fifth stage serves to laterally limit the waveguide in the BRWL 30.

The stages shown within the planar layer structure correspond to respective taperings of the waveguide structures in sections to improve the vertical cross-coupling properties. Accordingly, the structure shown also comprises a total of five tapering areas. The first tapering concerns the ridge of the DWL 10 and can be formed together with the first stage (e.g. by ridge patterning). The second tapering concerns the wave-guiding layers (18, 20, 22) of the DWL 10 and can be formed together with the second stage (e.g. by etching through the actual laser structures). The third tapering concerns the second contact layer 24 of the DWL 10 and can be formed together with the third stage (e.g. etching through second n-contact layer). Accordingly, the fourth tapering concerns the first cladding layer 32 of the BRWL 30 and may be formed together with the fourth stage (e.g. by means of shallow etching). In particular, the fourth tapering enables an improvement of the coupling to the Bragg mode in the BRWL by suppressing the excitation of unwanted parasitic coupling modes. Finally, the fifth tapering particularly concerns the wave-guiding layers (36, 38, 40) of the BRWL 30 and can be formed together with the fifth stage (e.g. by means of deep etching). The fifth tapering may also comprise at least a partial area of the second Bragg reflector 42. In principle, however, the fifth tapering could also comprise only the first Bragg reflector 34 or at least a partial area of the wave-guiding layers 36, 38, 40 in this exemplary embodiment.

Furthermore, the diagram shows the approximate course of the vertical cross-coupling from the DWL 10 into the BRWL 30 as an arrow extending in a longitudinal direction. Due to the tapered structure according to the invention, an increased coupling factor can be achieved for the cross-coupling from the DWL 10 into the BRWL 30 compared to a corresponding planar layer structure with a reduced number of stages or without tapers. However, it should be noted that the number, depth and position of the individual stages and/or taperings in particular are only described here by way of example and that these parameters can be varied and adapted depending on the material system used, the geometric dimensions and the desired coupling properties. In particular, depending on the chosen design, it may also be possible to omit an additional insertion of stages and/or taperings.

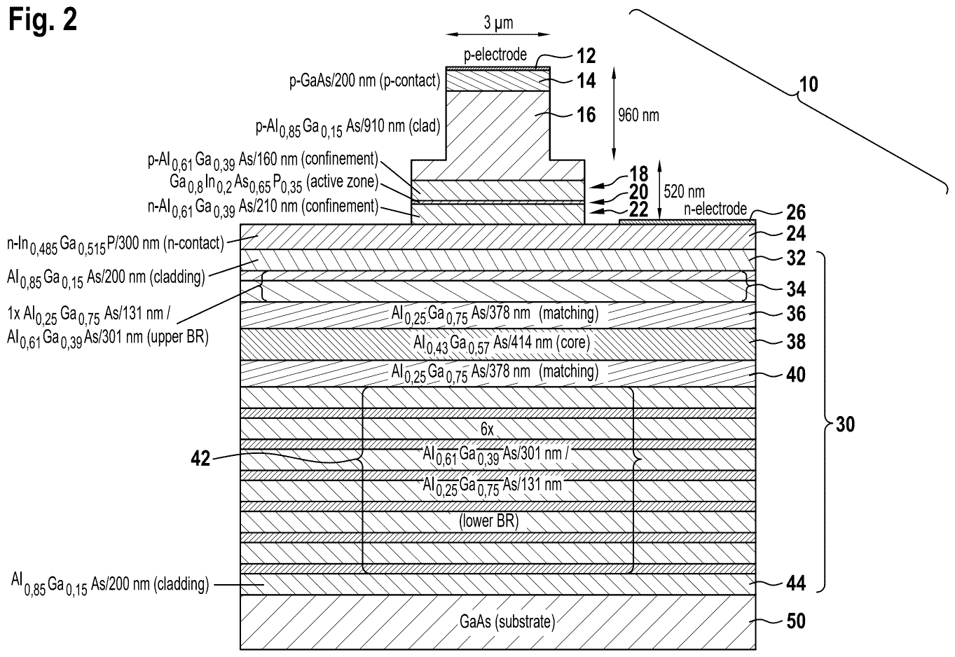

FIG. 2 shows a cross-sectional view of the photon pair source according to the invention of FIG. 1 in lateral direction along the drawn cutting surface A. The planar layer structure described above can be recognized accordingly. In addition to the structure shown, exemplary compositions for a possible planar layer structure in a GaAs-based material system with the corresponding preferred dimensions were also drawn in. However, these are not intended to limit the monolithically integrated photon pair source according to the invention neither to this material system nor to the ranges of values and parameters shown; rather, it is intended to be a purely illustrative example of a concrete practical implementation. All modifications and adaptations compatible with the appended claims, for example concerning the materials, layer thicknesses and/or layer sequences, are expressly intended to be included within the scope of this disclosure. It is readily apparent to the person skilled in the art that dimensions, for example, must always be considered with regard to the material system used, the wavelength ranges used and the structures used and are therefore only suitable for the concrete description of individual specific embodiments of the present invention.

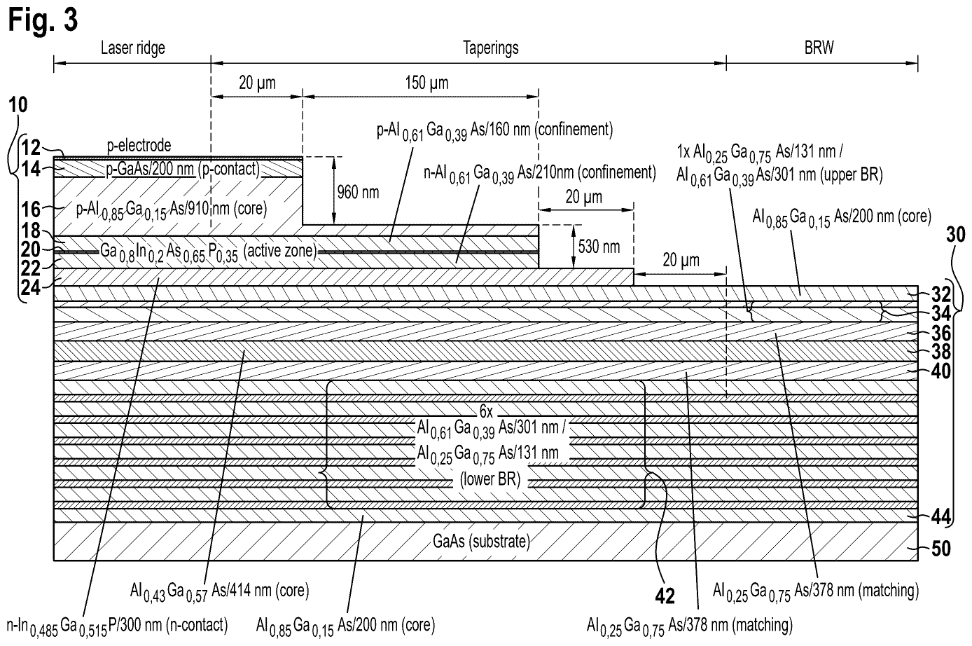

FIG. 3 shows a cross-sectional view of the photon pair source according to the invention of FIG. 1 in longitudinal direction along the drawn cutting surface B. The planar layer structure described as an example in FIG. 1 can also be seen in this cross-section. All statements and assumptions made in this regard in the description of FIG. 2 apply accordingly.

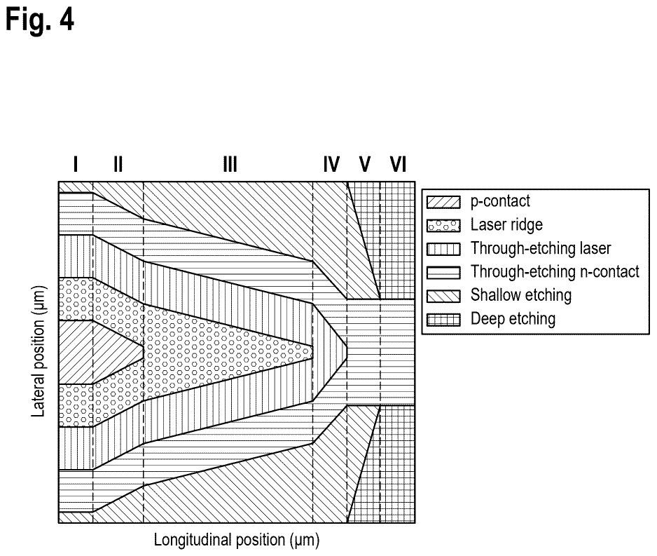

FIG. 4 shows a top view of an exemplary embodiment of a monolithically integrated photon pair source according to the invention to illustrate the several consecutive etching steps in an associated method for manufacturing it. As described above for FIG. 1, a tapering of the waveguide can be seen several times from left to right, so that pump radiation from the laser mode of the DWL can be cross-coupled into a higher vertical mode (Bragg mode) of the BRWL. The depth to which etching is possible at the corresponding point of the structure according to the invention (p-contact ≙no etching) can be seen in the corresponding legend. The segments of the structure within which the opening angle of a tapering does not change are identified by Roman numerals (I-VI).

A possible set of parameters for the structure shown could be as follows:
Spacing between etching steps: 2 μm
lateral extension of the tips: 0.5 μm
Width of the BRWL adapted for SPDC: 5 μm
Length segment III: 150 μm
Length of other segments: 20 μm

Using 2D+z finite difference simulations, a coupling efficiency of up to 40% between the laser mode and the Bragg mode could be calculated for the specific embodiment described in this application.

### LIST OF REFERENCE SIGNS

10 Dielectric waveguide (DWL)
12 First electrode (e.g. p-electrode)
14 First contact layer (e.g. p-contact layer)
16 First clad layer (e.g. p-clad layer)
18 First confinement or first waveguide layer (e.g. p-waveguide layer)
20 Active layer (e.g. quantum well layer)
22 Second confinement or second waveguide layer (e.g. n-waveguide layer)
24 Second contact layer (e.g. n-contact layer)
26 Second electrode (e.g. n-electrode)
30 Bragg reflection waveguide (BRWL)
32 First cladding layer (e.g. upper cladding layer)
34 First Bragg reflector (e.g. upper Bragg reflector, preferably a single Bragg reflector pair)
36 First matching layer (e.g. upper matching layer)
38 Waveguide layer
40 Second matching layer (e.g. lower matching layer)
42 Second Bragg reflector (e.g. lower Bragg reflector, preferably six Bragg reflector pairs)
44 Second cladding layer (e.g. lower cladding layer)
50 Substrate
KA Coupling portion
I Planar layer system
II First tapering portion (e.g. contact layer tapering)
III Second tapering portion (e.g. confinement tapering)
IV Third tapering portion (e.g. contact layer tapering)
V Fourth tapering portion (e.g. cladding tapering)
VI Fifth tapering portion (e.g. reflector tapering)

We claim:

1. A monolithically integrated photon pair source, comprising:
a dielectric waveguide (DWL); and
a Bragg reflection waveguide (BRWL) arranged to provide quantum-mechanically entangled photon pairs by means of spontaneous parametric down conversion, wherein the BRWL is disposed below the DWL and they are interacting with one another in a common coupling portion such that pump radiation guided in the DWL is cross-coupled into the BRWL.

2. The monolithically integrated photon pair source of claim 1, wherein the DWL is formed as a passive waveguide with an input for coupling in the pump radiation.

3. The monolithically integrated photon pair source of claim 1, wherein the DWL is formed as an active waveguide with an active layer.

4. The monolithically integrated photon pair source of claim 3, wherein the DWL is formed as a ridge waveguide with an electrode disposed on a ridge and a contact layer disposed on the lower surface of the DWL.

5. The monolithically integrated photon pair source of claim 1, wherein the BRWL has a cladding layer on its upper surface.

6. The monolithically integrated photon pair source of claim 1, wherein the BRWL comprises a waveguide layer surrounded at least below by at least one Bragg reflector pair.

7. The monolithically integrated photon pair source of claim 6, wherein the number of Bragg reflector pairs above and below the waveguide layer is formed asymmetrically, in particular the number above the waveguide layer being less than that below the waveguide layer.

8. The monolithically integrated photon pair source of claim 1, wherein in the coupling direction first a tapering of the lateral width of the DWL and subsequently a tapering of the lateral width of the BRWL occurs, wherein the smallest lateral width of the BRWL in the common coupling portion is greater than the largest lateral width of the DWL.

9. The monolithically integrated photon pair source of claim 8, wherein the tapering of the DWL and the BRWL each occurs in sections within the individual waveguide structures.

10. A method for manufacturing a monolithically integrated photon pair source of claim 8, the method comprising:
providing a respective planar layer system;
forming the taperings with several consecutive etching steps, wherein deeper layers of the layer system are partially exposed with each etching step.

11. A method for manufacturing a monolithically integrated photon pair source of claim 9, the method comprising:
providing a respective planar layer system;
forming the taperings with several consecutive etching steps, wherein deeper layers of the layer system are partially exposed with each etching step.
